(19) United States
(12) Patent Application Publication
(10) Pub. No.: US 2006/0091669 A1
(43) Pub. Date: May 4, 2006

(54) Label system with fill line indicator

(75) Inventor: Laura Wilkinson, North Haledon, NJ (US)

Correspondence Address: DAVID W. HIGHET, VP AND CHIEF IP COUNSEL;BECTON, DICKINSON AND COMPANY, 1 BECTON DRIVE, MC 110, FRANKLIN LAKES, NJ, 07417-1880, US

(73) Assignee: Becton, Dickinson and Company, Franklin Lakes, NJ (US)

(21) Appl. No.: 11/262,544

(22) Filed: Oct. 28, 2005

Related U.S. Application Data
(60) Provisional application No. 60/624,097, filed on Nov. 1, 2004.

(51) Int. Cl. B42D 15/00

(52) U.S. Cl. 283/74

(57) ABSTRACT

The label system is associated with a collection container and provides a visual indication for determining when a desired fill volume has been reached. The system includes a first label with identification information and an opaque section attached to the container. The opaque section includes a gap that indicates the desired fill volume. The identification information on the first label may be readable by a scanner. The first label includes first alignment indicia attached to the container. A second label including second alignment indicia to align with the first alignment indicia is provided on the first label. The second label interferes with the ability of a scanner to read the identification information on the first label. The second label is configured to not cover a portion of the first label. This portion may be chosen to be of a color that corresponds to the color of the container closure.

This application claims priority of U.S. Provisional Patent Application No. 60/624,097 filed Nov. 1, 2004.

### BACKGROUND OF THE INVENTION

1. Field of the Invention

The present invention, in general, relates to a label and labeling system for collection containers, and, more particularly, to a label with a fill line indicator and a labeling system with alignment indicia that may be color-coded.

2. Description of Related Art

Proper placement of a printed label on a container is important for ensuring subsequent reading of the information printed on the label. If not properly placed, the printed information is not easily seen, or cannot easily be scanned, by automated equipment.

Proper placement of bar code information on a specimen collection container is important to ensure proper scanning of the encoded information by various clinical equipment and analytical testing instrumentation. If the bar code information is not properly positioned on the sample container, the scanner of the instrumentation may not be able to read the bar code, thus requiring the operator to manually scan the bar code information, or manually enter the bar code information into the instrumentation.

U.S. Pat. No. 6,428,640, which is hereby incorporated by reference, discloses a system and method for proper alignment and placement of a label on a container. The label system includes a first label and a second label. The first label is located on a container and includes alignment indicia. The alignment indicia may be in the form of a protrusion having a distinct shape, such as a triangle or a diamond. The second label includes an alignment area corresponding to the alignment indicia of the first label. The alignment area may be in the form of an opening or a transparent portion. The second label is positioned on the container such that the alignment area of the second label is aligned with the alignment indicia of the first label.

This system, however, does not incorporate a convenient system for allowing the user, typically a phlebotomist, to visually determine that the correct volume of blood has been drawn. Additionally, current systems lack a means for placing a second label over a first label without obscuring information about tube or container type which often is indicated on the first label. Often, the second label does not indicate what type of tube was collected while the first label does. When placing the second label over the first label, valuable information about tube type that is visually observable can be lost. Therefore, there is a need for a system that does not obscure indication of tube or container type indicated by the first label, while still maintaining alignment functionality of a first label placed on the second label. Furthermore, the alignment indicia on the first label does not provide any indication of what kind of sample is in the container, especially when the closure is removed and the tube becomes visually indistinguishable from other containers that have the first label obscured with a secondary label and also are lacking their closure.

Accordingly, a need exists for a label that improves the user's ability to quickly and visually identify how much blood has been drawn into an evacuated container and furthermore if the amount of blood drawn is within a visual range easily recognized by the user. A further need exists for a way to visually identify the alignment indicia on a label to allow for a visual indication of the sample container type. Additionally, a need exists for a way to visually maintain identification of the container after the first label has been obscured or is no longer legible and the closure has been removed.

### SUMMARY OF THE INVENTION

A first embodiment of the present invention is drawn to a collection container that includes a first label with identification information and an opaque section. The opaque section comprises a gap that indicates a desirable fill volume for the collection container. The container may further comprise a closure for maintaining a reduced pressure with respect to atmospheric pressure within the container and sealed with the closure. The closure may include, for example, an elastomeric septum and a plastic septum cap. The closure may include, for example, container type indicia that correlates to the chosen closure color.

The identification information may include, for example, alphanumeric indicia, barcode information or both, and the gap may indicate upper and lower fill volumes for the collection container which include the desired fill volume. The identification information may further include, for example, non-alphanumeric indicia in the form of raised textural indicia along with or in place of the alphanumeric indicia and barcode. The identification information may include, for example, a description of at least one of a desired fill volume, lower fill volume, and upper fill volume. At least a portion of the opaque section may correspond to the color of the closure of the container or some other color-associated container type identification system. This allows for, for example, easy identification of the sample in the container. The first label may be positioned on the collection container at a position where the desirable fill volume of the collection container is aligned with an expected fill volume of the collection container. The first label may also be first positioned on the collection container and after placement, have printed on the first label an opaque section comprising a gap that indicates a desirable fill volume for the collection container.

A second embodiment of the present invention is drawn to a label selection system including the collection container. The system comprises a first label adhered to the collection container and includes identification information to be read by a scanner, such as a barcode or RFID scanner, and first alignment indicia. The system further comprises a second label including second alignment indicia to align with the first alignment indicia provided on the first label. The second label may be associated with the first label so as not to cover or obscure (i.e., leave exposed) a portion of the first label when properly aligned to the first label. This portion of the first label may be chosen to be of a color that corresponds to the color of the closure of the container. For example, the exposed portion may be red in color and the container may be a serum collection container which typically has a red closure, closure cap, or both. This color coordination facilitates visual indication of the type container used for collecting a biological sample such as blood. The second label may be adapted and positioned to interfere with the ability of a scanner to read the identification information on the first label, or optionally add information specific regarding the patient demographics for the sample collected in the container.

In accordance with another embodiment of the present invention, a method is provided for labeling the collection container to readily identify the contents of the container. The method generally comprises providing a collection container with an affixed first label adhered to the outside surface of the collection container, and affixing the second label to the first label such that a portion of the first label remains exposed by the second label. The first label comprises indicia to be read by a scanner and first label alignment indicia. The second label comprises second label alignment indicia to align with the first label alignment indicia. The exposed portion of the first label may comprise a color that corresponds to a certain type of container, such as a serum collection container (typically red) or a citrate anticoagulant container (typically light blue).

The method may further comprise attaching a closure to an opening of the collection container. The exposed portion may be of a color selected to relate to a color chosen for a closure disposed in an opening of the collection container. The method may further comprise preselecting the color of the first label to be similar to the color of a closure for the container. The first label may comprise alignment symbology and the second label may comprise an alignment area. The method may then further comprise affixing the second label on the container with the alignment area of the second label in alignment with the alignment symbology of the first label such that the alignment symbology is detectable through the alignment area, thereby facilitating proper alignment of the second label on the container.

Further details and advantages of the present invention will become apparent upon reading the following detailed description in conjunction with the accompany drawings.

### BRIEF DESCRIPTION OF THE DRAWINGS

FIG. 1 illustrates a collection container including a first label having a fill line indicator and alignment indicia and a container closure, in accordance with an embodiment of the present invention;

FIG. 2 illustrates a second label including alignment indicia corresponding to the alignment indicia of first label of the collection container of FIG. 1;

FIG. 3 illustrates a collection container as in FIGS. 1 and 2 including the second label of FIG. 2 properly aligned on the container; and

FIGS. 4a-4c illustrate alternative embodiments of the presnet invention in connection with the first label.

### DESCRIPTION OF THE PREFERRED EMBODIMENTS

Embodiments of the present invention will be described with reference to the accompanying figures, wherein like reference numbers correspond to like elements throughout.

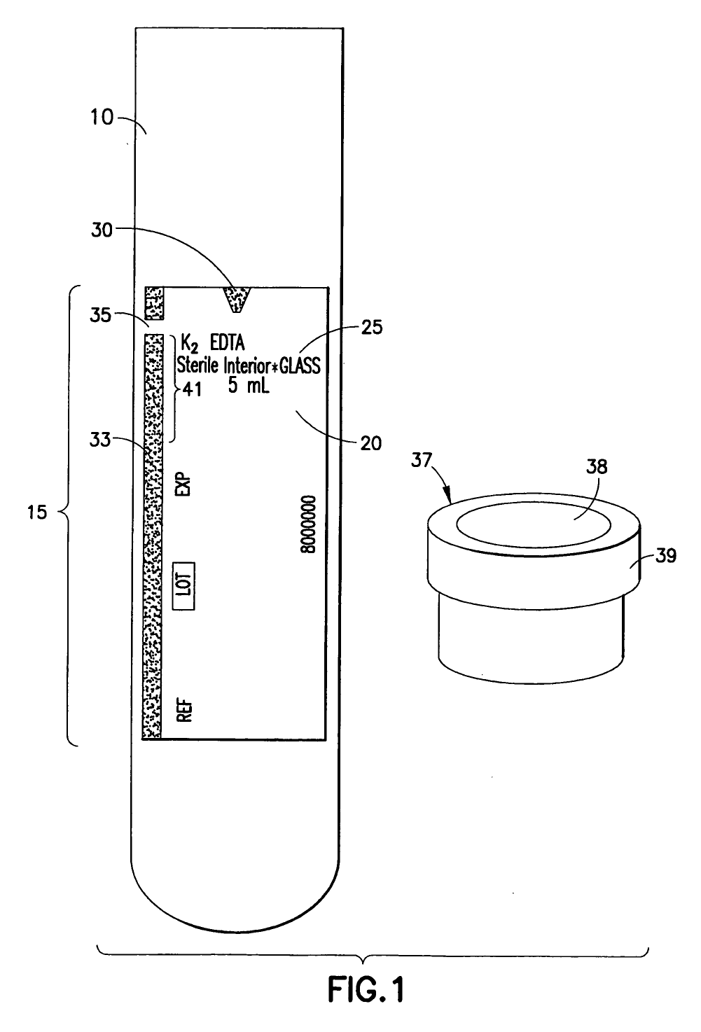

With reference to FIG. 1, container 10 includes a first label 20 affixed to the outer surface of the container 10 in label bearing area 15. First alignment indicia 30 and opaque bar 33 are printed on first label 20. Opaque bar 33 includes a gap 35 that indicates a desired or expected fill volume for the container 10. Opaque bar 33 with gap 35 provides a user of the container 10, such as a phlebotomist, with a quick, visual indication that the proper and intended amount of blood to be collected has been drawn and deposited in the container 10.

Container 10 further includes a closure 37. The closure 37 generally includes an elastomeric septum 38 and a plastic septum cap 39. The closure 37 may have a color that gives a visual indication of the contents of container 10. For instance, a blue closure 37 may indicate a citrate tube, a red closure 37 may indicate a serum tube, a green closure 37 may indicate a heparin tube, a purple closure 37 may indicate an EDTA tube, and a gray closure 37 may indicate a fluoride tube, as examples. At least a portion 41 of opaque bar 33 of first label 20, in accordance with an embodiment of the invention, has a color that corresponds to the color of the closure 37 of the container 10, thus allowing for quick, visual confirmation of the type of sample in the container 10. Desirably, the entire opaque bar 33 of first label 20 may have a color that corresponds to the color of the closure 37 of the container 10. A further function of the closure 37 is to seal the container 10, for example to maintain reduced pressure with respect to atmospheric pressure within the container 10.

First label 20 may further contain additional identification information. The identification information may include a one-dimensional or two-dimensional bar code, such as that associated with identification label 40 discussed herein, and/or alphanumeric indicia 25. The identification information may include information identifying the type of the container 10, the manufacturer lot number, the size and/or shape of the container 10 and the reagents included within the container 10. The alphanumeric indicia 25 may be supplemented or replaced with non-alphanumeric indicia 26, for example in the form of raised textural indicia, so that the user could also obtain information as to the contents of the container 10 through his or her fingertips.

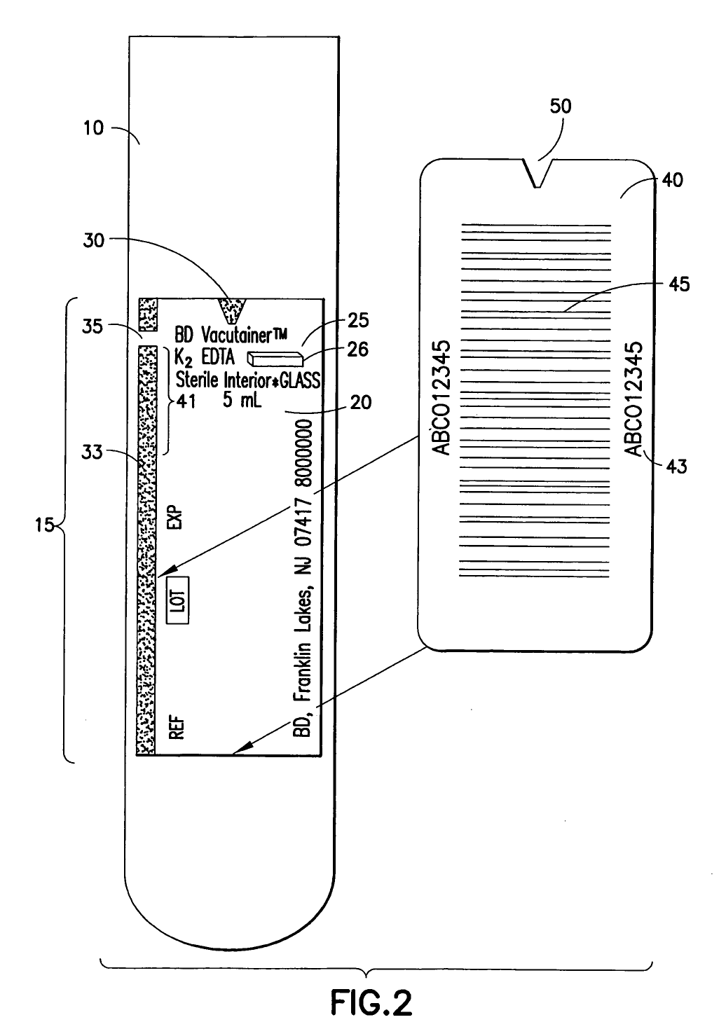

With reference to FIG. 2, and with continuing reference to FIG. 1, a second label 40 may be provided for placement on container 10. Identification label 40 may include encoded or printed information thereon, such as a bar code 45 and/or alphanumeric indicia 43, either or both may represent an identification of the sample contained within the container 10, information identifying the patient, what analyses are to be conducted on the sample and sampling information such as date and time of sampling.

Second label 40 is capable of being affixed over first label 20. Second label 40 includes second alignment indicia 50 corresponding to first alignment indicia 30 of first label 20. Second alignment indicia 50 may be an opening or notched cut-away of second label 40. For example first alignment indicia 30 is in the form of a V-shaped triangle and second alignment indicia 50 is a V-shaped notch appearing on the edge of second label 40.

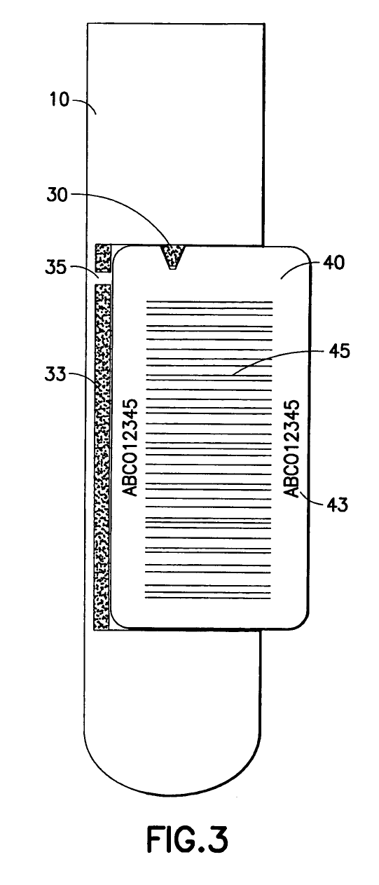

With reference to FIG. 3 and with continuing reference to FIGS. 1 and 2, second label 40 is positioned on container 10 such that second alignment indicia 50 of second label 40 is aligned with first alignment indicia 30 of first label 20. First alignment indicia 30 is detectable (e.g., viewable) through second alignment indicia 50, thereby assuring proper alignment of the identification label on container 10. Further, the placement of second label 40 on first label 20 may interfere with a scanner's ability to read the information on first label without interfering with opaque section 33. The information on first label 20 may therefore be replaced with the information on second label 40 and gap 35 in opaque section 33 can still be used to visually check the fill volume.

In an additional embodiment of the present invention, first alignment indicia 30, or at least a portion thereof, has a color that corresponds to the color of the closure 37 of the container 10. Since first alignment indicia 30 is not covered by second label 40, alignment indicia 30 can be used to provide an indication of the type of sample in container 10 even when the closure 37 is removed.

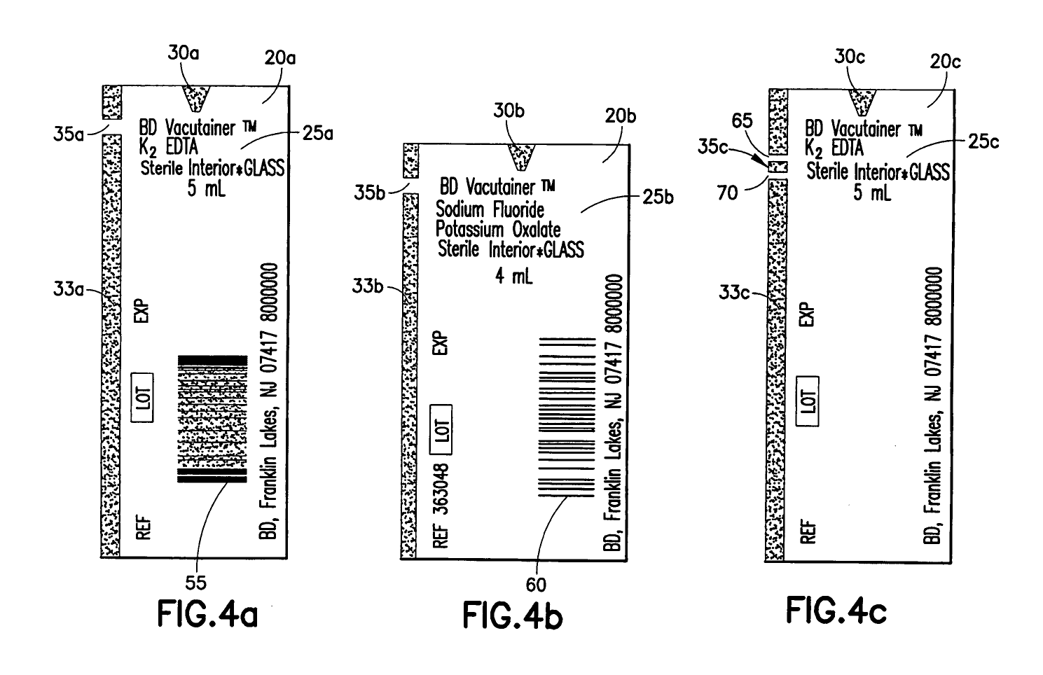

FIGS. 4a, 4b, and 4c provide several different embodiments of first label 20.

With reference to FIG. 4a, first label 20a includes first alignment indicia 30a and opaque bar 33a printed on first label 20a. Opaque bar 33a includes a gap 35a that indicates a desirable fill volume range for collection container 10a. First label 20a further contains additional identification information. The identification information can include a barcode such as, but not limited to, a two-dimensional bar code 55 and alphanumeric indicia 25a or non-alphanumeric indicia 26 as illustrated in FIG. 2. The identification information may include information identifying the specific type of the container, the manufacturer lot number, the size and/or shape of the container 10a, the expiration of the container and the reagents included within the container 10a.

With reference to FIG. 4b, first label 20b includes first alignment indicia 30b and opaque bar 33b printed on first label 20b. Opaque bar 33b includes a gap 35b that indicates a desirable fill volume for collection container 10b. Gap 35b indicates an upper fill volume 65 and a lower fill volume 70 of collection container 10b. Upper fill volume 65 and lower fill volume 70 include the desirable fill volume. The identification information can include a bar code 60, alphanumeric indicia 25b, or the non-alphanumeric indicia 26 illustrated in FIG. 2.

With reference to FIG. 4c, first label 20c includes first alignment indicia 30c and opaque bar 33c printed on first label 20c. Opaque bar 33c includes a gap 35c that indicates a desirable fill volume range for collection container 10c. Gap 35c indicates an upper fill volume 65 and a lower fill volume 70 of collection container 10c. Upper fill volume 65 and lower fill volume 70 include the desirable fill volume. The identification information can include alphanumeric indicia 25 or the non-alphanumeric indicia 26 illustrated in FIG. 2. (Note that, in the embodiment provided in FIG. 4c, situated in gap 35c is a marking that helps defines an upper fill volume indicator (defined between the marking and upper fill volume 65c) and the lower fill volume indicator (defined between the marking and lower fill volume 70c).)

First alignment indicia 30 can be in shapes other than a v-shape, such as a diamond or a circle, or polygonal. For ease of use, first alignment indicia 30 and second alignment indicia 50 should be shapes which are non-rotationally symmetrical, such as a polygon, to assure proper alignment in both a vertical and horizontal direction and prevent second label 40 from being improperly skewed or canted.

The fill volume indicator established by the first label including the opaque section provides the container with an indication as to the intended fill volume for a container when the container is positioned vertically upright, i.e., in a closure-up position. In this manner, the fill volume indicator provides a confirmation as to whether an amount of sample within the container is the desired fill volume for the tube. Such a fill volume indicator is particularly helpful in determining whether the amount of sample within a container matches the particular pre-determined draw volume for the specific collection container. For example, such blood collection containers include a negative pressure or vacuum within the interior of the container. In use, a blood collection needle accesses a patient's blood vessel, and is placed in fluid communication with the interior of the blood collection container. The negative pressure within the container draws a blood sample from the blood vessel, through the needle and into the interior of the collection container. Eventually, the pressure within the collection container is equilibrated with the blood pressure, at which time no additional sample is drawn into the container. Accordingly, the interior of the container may be evacuated to provide sufficient vacuum within the container to ensure that a predetermined volume of blood is drawn into the container based on that vacuum.

As noted above, collection containers may incorporate specific reagents therein, associated with a desired test to be performed on the sample. The amount of reagent may be particularly tailored to the specific intended volume of blood for the container. If the amount of sample drawn into the container is not matched with the specific intended volume, the reagent may not properly react with the sample, providing inaccurate testing results. In accordance with embodiments of the present invention, a mechanism is provided for ensuring that the proper intended volume of blood for the container is collected within the container. For example, long-term storage of evacuated collection containers can result in reduced vacuum therein, thereby reducing the draw volume for the container. Moreover, during an initial blood draw, the needle may include air therein which is displaced into the first collection container used in the draw. Such air may decrease the overall fill volume for the container, such that an insufficient amount of blood is drawn into the container for the reagent contained therein.

By providing the fill line indicator as in embodiments of the present invention, the user can confirm that the appropriate amount of sample intended for that container has in fact been collected within that container immediately after the blood draw. The label including the opaque section with the gap therein provides an immediate visual confirmation to the user that the appropriate sample is contained therein, with the sample appearing in the gap or partially or completely obstructing the gap to confirm the volume contained therein. Moreover, by providing the fill volume indicator on the label, the label can be positioned appropriately on the container by the manufacturer at the time when the container is evacuated, thereby ensuring proper matching of the intended container volume with the vacuum therein. Also, in this manner, a single container size can be used for a number of different draw volumes by matching the intended sample volume with the vacuum for the container, and aligning the gap in the opaque section on the label with that intended sample volume.

Still further, the fill volume indicator can provide confirmation to a lab technician as to whether the volume contained within a container is the intended fill volume, particularly for a specific type of container. This can confirm whether a sample has already been removed from the container for analysis. Also, by matching the indicators on the label with the type of container, the lab technician can confirm not only the proper volume contained therein, but also can confirm the type of container, even with the closure or stopper removed therefrom.

While embodiments of the present invention was described with reference to preferred embodiments of the collection container and label selection system, those skilled in the art may make modifications and alterations to embodiments of the present invention without departing from the scope and spirit of the invention. Accordingly, the above detailed description is intended to be illustrative rather than restrictive. The invention is defined by the appended claims, and all variations of the invention that fall within the meaning and range of equivalency of the claims are to be embraced within their scope.

What is claimed is:

1. A collection container comprising:
a first label attached to a collection container, the first label comprising identification information and an opaque section,
wherein the opaque section comprises a gap that indicates a desirable fill volume for the collection container.

2. The container of claim 1, wherein the identification information includes at least one of alphanumeric indicia and barcode information.

3. The container of claim 1, wherein the identification information includes non-alphanumeric indicia in the form of raised textural indicia.

4. The container of claim 1, wherein the gap indicates upper and lower fill volumes for the collection container, wherein the upper and lower fill volumes include the desirable fill volume.

5. The container of claim 4, wherein the identification information comprises a description of at least one of the desirable fill volume, the lower fill volume, and the upper fill volume.

6. The container of claim 1, wherein the first label further comprises alignment indicia for the application of a second label to the collection container.

7. The container of claim 1, wherein the container is sealed with a closure.

8. The container of claim 7, wherein at least a portion of the opaque

9. The container of claim 7, wherein the closure comprises an elastomeric septum and a plastic septum cap.

10. The container of claim 7, wherein the closure provides for maintaining a reduced pressure with respect to atmospheric pressure for the container sealed with the closure.

11. The container of claim 1, wherein the first label is positioned on the collection container at a position where the desirable fill volume of the collection container is aligned with an expected fill volume of the collection container.

12. A label selection system for labeling collection containers, the system comprising:
a collection container;
a first label adhered to the collection container, wherein the first label comprises indicia to be read by a scanner and first label alignment indicia; and
a second label to be affixed to the first label, wherein the second label comprises second label alignment indicia to align with the first label alignment indicia, wherein a portion of the first label is not covered by the second label when affixed thereto, and the portion of the first label is of a color that corresponds to a certain type of container.

13. The system of claim 12, wherein the portion is a color selected to relate to a color chosen for a closure attached to an opening of the collection container.

14. The system of claim 12, wherein the portion is generally red in color and the container is a serum collection container.

15. A method of preparing a labeling system and labeling a collection container for assisting in readily identifying the contents of the container comprising:
affixing a first label to the collection container wherein the first label comprises indicia to be read by a scanner and first label alignment indicia; and
providing a second label adapted to be affixed to the first label thereby creating an obscured portion and an exposed portion, wherein the second label comprises second label alignment indicia to align with the first label alignment indicia, and wherein the exposed portion of the first label is of a color that corresponds to a certain type of container.

16. The method of claim 15, wherein the color is selected to relate to a color chosen for a closure disposed in an opening of the container.

17. The method of claim 16, wherein the exposed portion is generally red in color and the container is a serum collection container.

18. The method of claim 15, further comprising attaching a closure to an opening of the container.

19. The method of claim 15, further comprising preselecting the color of the exposed portion of the first label to be similar to the color of a closure for the container.

20. The method of claim 15, further comprising affixing the second label to the first label and creating the obscured portion and the exposed portion.

21. The method of claim 20, wherein the first label comprises alignment symbology and the second label comprises an alignment area, and wherein when the second label is affixed to the first label, the alignment area of the second label is aligned with the alignment symbology of the first label such that the alignment symbology is detectable through the alignment area, thereby assuring proper alignment of the second label on the container.
